(19) United States
(12) Patent Application Publication
(10) Pub. No.: US 2019/0128545 A1
(43) Pub. Date: May 2, 2019

(54) Air Exchanging Device

(71) Applicant: Sunonwealth Electric Machine Industry Co., Ltd., Kaohsiung City (TW)

(72) Inventors: Alex Horng, Kaohsiung City (TW); Wan-Ling Hu, Kaohsiung City (TW); Li-Yang Lyu, Kaohsiung City (TW)

(21) Appl. No.: 16/129,853

(22) Filed: Sep. 13, 2018

(30) Foreign Application Priority Data
Nov. 1, 2017 (TW) 106137802

(51) Int. Cl. F24F 7/013; F24F 3/16

(52) U.S. Cl. CPC F24F 7/013; B01D 46/2411; F24F 3/1603

(57) ABSTRACT

An air exchanging device according to the invention is mounted to a wall. An inner side of the wall is the indoor space, and an outer side of the wall is the outdoor space. The wall has an installation hole. The air exchanging device includes a housing, a first fan unit and a second fan unit. The housing has a compartment. The housing has a first through-hole, a second through-hole and a third through-hole. The first fan unit is received in the compartment and includes a first air inlet intercommunicating with the second through-hole, and a first air outlet intercommunicating with the first through-hole. The second fan unit is received in the compartment. The second fan unit includes a second air inlet intercommunicating with the third through-hole, and a second air outlet intercommunicating with the second through-hole.

### CROSS REFERENCE TO RELATED APPLICATION

The application claims the benefit of Taiwan application serial No. 106137802, filed on Nov. 1, 2017, and the entire contents of which are incorporated herein by reference.

### BACKGROUND OF THE INVENTION

### 1. Field of the Invention

The present invention generally relates to an air exchanging device and, more particularly, to an air exchanging device which circulates the air between the indoor and outdoor spaces.

### 2. Description of the Related Art

A conventional air exchanging device is generally mounted to a wall of the building. An inner side of the wall is the indoor space, and an outer side of the wall is the outdoor space. The wall needs to form an air inlet and an air outlet. A fan is mounted to each of the inlet and the air outlet. During the operation of the fans, the external air can be guided into the indoor space via the air inlet, and the internal air can be guided to the outdoor space. Accordingly, the ventilation effect is attained.

However, the installation of the fans requires the creation of different installation holes for installation purpose of two types of fans. Disadvantageously, the construction and assembly of the fans are inconvenient, and the defect in appearance of the wall results. In addition, since the conventional air exchanging device does not include an air filter, the user needs to purchase an air cleaner. Thus, the use of the conventional air exchanging device is inconvenient.

However, it is necessary to improve the conventional air exchanging device.

### SUMMARY OF THE INVENTION

It is therefore the objective of the invention to provide an air exchanging device which integrates all of the required components in one and allows for easy installation and replacement for a filter.

The air exchanging device according to the invention is mounted to a wall. An inner side of the wall is the indoor space, and an outer side of the wall is the outdoor space. The wall has an installation hole. The air exchanging device includes a housing, a first fan unit and a second fan unit. The housing has a compartment. The housing has a first through-hole, a second through-hole and a third through-hole. The first fan unit is received in the compartment and includes a first air inlet intercommunicating with the second through-hole, and a first air outlet intercommunicating with the first through-hole. The second fan unit is received in the compartment. The second fan unit includes a second air inlet intercommunicating with the third through-hole, and a second air outlet intercommunicating with the second through-hole.

Based on this, with the air exchanging device according to the invention, the wall can have only a single installation hole. The second through-hole of the housing intercommunicates with a tube assembly mounted to the installation hole of the wall. In this arrangement, during the operation of the first and second fan units, the external air can be guided from the second through-hole to the first air inlet of the first fan unit, and then is guided to the indoor space via the first air outlet of the first fan unit. Furthermore, the internal air can also be guided from the second air inlet to the second air outlet of the second fan unit, and then is guided to the outdoor space via the second through-hole. Accordingly, the air is circulated between the indoor and outdoor spaces to provide a desired ventilation effect.

In an example, the second through-hole includes an inlet portion intercommunicating with the first air inlet, and an outlet portion intercommunicating with the second air outlet. Accordingly, the wall requires only one installation hole for entry and exit of the air.

In the example, the second through-hole of the housing is divided into the inlet portion and the outlet portion by an air guider. Accordingly, turbulence is avoided.

In the example, the air guider includes at least a tube assembly. Accordingly, an air-guiding effect is improved.

In the example, the tube assembly includes a tube divider disposed therein and dividing an interior of the tube assembly into a first air channel and a second air channel. The first air channel intercommunicates with the inlet portion of the second through-hole and the second air channel intercommunicates with the outlet portion of the second through-hole. Accordingly, the first and second air channels are able to guide the air.

In the example, the tube divider is integrally formed with a plurality of fins received in the first and second air channels. Accordingly, the heat exchange effect is improved.

In the example, the air exchanging device further includes a first filter disposed in the compartment and dividing the compartment into a first compartment and a second compartment. Accordingly, the air can be filtered.

In the example, the first filter includes a first side board having a first pulling portion, and the housing includes an inner member having a fourth through-hole corresponding to the first side board. Accordingly, convenient replacement is achieved.

In the example, the housing includes a rail, and the first filter is detachably mounted to the rail. Accordingly, convenient replacement of the first filter is achieved.

In the example, the housing includes a grid plate disposed at the first through-hole. Accordingly, the intrusion of foreign debris though the first air outlet, such as insects, can be prevented.

In the example, the air exchanging device further includes a second filter coupled with the first fan unit and covering the first air inlet. The second filter includes a first end, a second end, and a hole extending from the first end to the second end thereof. Accordingly, the air can be filtered.

In the example, a filtration wall is disposed between the first and second ends of the second filter. Accordingly, the air-guiding effect in the lateral direction can be improved and the thickness of the housing can be reduced.

In the example, the first end of the second filter is coupled with a third side board, the first fan unit includes a plurality of first positioning portions surrounding the first air inlet thereof, and the third side board includes a plurality of second positioning portions coupled with the plurality of first positioning portions. Accordingly, the assembly is convenient.

In the example, the plurality of second positioning portions is coupled with the plurality of first positioning portions by ways of magnetic attraction, engagement or adhesion. Accordingly, the assembly is convenient.

In the example, the second end of the second filter is coupled with a second side board, and the hole forms an air-guiding space. Accordingly, the air can be guided through the first air inlet more smoothly.

In the example, the second side board includes a second pulling portion, and the housing includes an inner member having a fifth through-hole corresponding to the second filter. Accordingly, convenient replacement of the second filter is achieved.

In the example, an air freshener is disposed in the air-guiding space and is hanged on a post or a hook. Accordingly, the air is scented with fragrance.

In the example, the air-guiding space includes a receiving portion receiving a fragrance liquor. Accordingly, the air is scented with fragrance.

In the example, the air exchanging device further includes a second filter coupled with the first fan unit and covering the first air inlet, and the second filter has interstices smaller than or equal to that of the first filter. Accordingly, the small particles can be filtered.

In the example, the first filter includes a filtration material which meets an air quality standard of PM 2.5, a High Efficiency Particulate Air filter, an Ultra Low Penetration Air filter, or a Volatile Organic Compounds Air filter. Accordingly, the small particles and unpleasant smell of the air can be filtered out.

In the example, the second filter includes a filtration material which meets an air quality standard of PM 2.5, a High Efficiency Particulate Air filter, an Ultra Low Penetration Air filter, or a Volatile Organic Compounds Air filter. Accordingly, the small particles and unpleasant smell of the air can be filtered out.

In the example, the first, second and third through-holes are formed on different faces of the housing. Accordingly, the smoothness in the flow of air can be improved.

In the example, the first filter is a Volatile Organic Compounds Air filter and the second filter includes a filtration material which meets an air quality standard of PM 2.5. Accordingly, the small particles and unpleasant smell of the air can be filtered out.

### BRIEF DESCRIPTION OF THE DRAWINGS

The present invention will become more fully understood from the detailed description given hereinafter and the accompanying drawings which are given by way of illustration only, and thus are not limitative of the present invention, and wherein:

FIG. 1 is an exploded, perspective view of an air exchanging device according to a first embodiment of the invention.

FIG. 2 is a partially assembled view of the air exchanging device in FIG. 1.

FIG. 3 shows the air exchanging device in FIG. 2 which is coupled with an air guider.

FIG. 4 is an exploded, perspective view of an air exchanging device according to a second embodiment of the invention.

FIG. 5 a partially assembled view of the air exchanging device in FIG. 4.

FIG. 6 is an exploded, perspective view of an air exchanging device according to a third embodiment of the invention.

FIG. 7 a partially assembled view of the air exchanging device in FIG. 6.

FIG. 8 shows an air freshener to be disposed in a second filter of the air exchanging device of the third embodiment of the invention.

FIG. 9 shows a fragrance liquor to be disposed in the second filter of the air exchanging device of the third embodiment of the invention.

FIG. 10 is a partially assembled, perspective view of an air exchanging device according to a fourth embodiment of the invention.

In the various figures of the drawings, the same numerals designate the same or similar parts. Furthermore, when the terms “first”, “second”, “third”, “fourth”, “inner”, “outer” and similar terms are used hereinafter, it should be understood that these terms have reference only to the structure shown in the drawings as it would appear to a person viewing the drawings, and are utilized only to facilitate describing the invention.

### DETAILED DESCRIPTION OF THE INVENTION

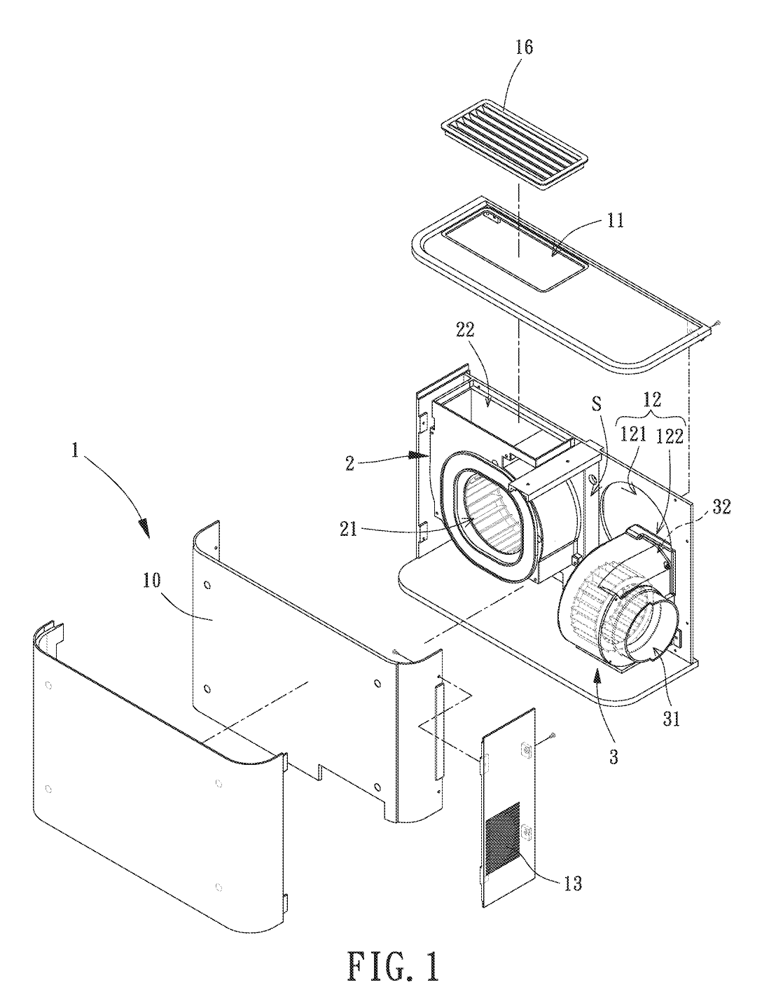

FIG. 1 shows an air exchanging device according to a first embodiment of the invention. The air exchanging device is mounted to a wall. An inner side of the wall is the indoor space, and an outer side of the wall is the outdoor space. The wall has an installation hole. The air exchanging device includes a housing 1, a first fan unit 2 and a second fan unit 3. The housing 1 has a compartment S. The first fan unit 2 and the second fan unit 3 are disposed in the compartment S.

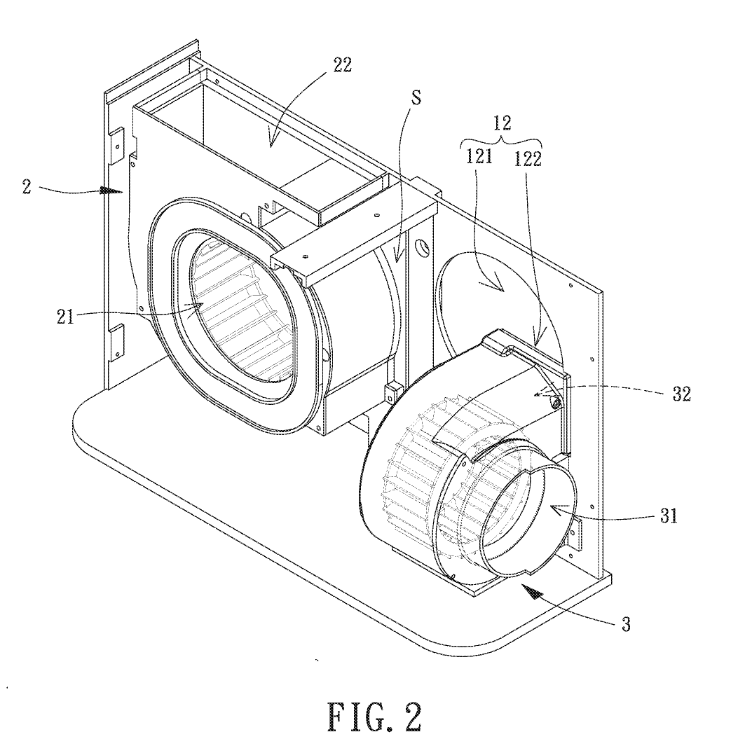

Referring to FIGS. 1 and 2, the housing 1 includes a first through-hole 11, a second through-hole 12 and a third through-hole 13. The first through-hole 11, the second through-hole 12 and the third through-hole 13 are formed on different faces of the housing 1. The first through-hole 11 and the third through-hole 13 intercommunicate with the indoor space. The second through-hole 12 intercommunicates with the outdoor space. The housing 1 includes a grid plate 16 disposed at the first through-hole 11.

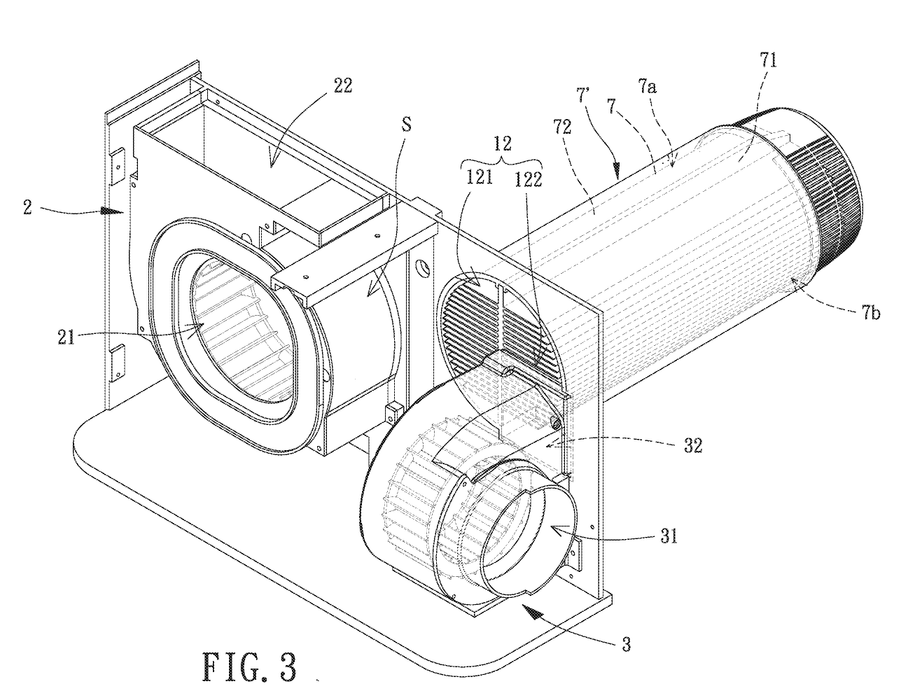

Referring to FIGS. 2 and 3, the second through-hole 12 can be divided into an inlet portion and an outlet portion by an air guider 7′. The air guider 7′ is disposed at the installation hole of the wall. The air guider 7′ at least includes a tube assembly 7. In this embodiment, the second through-hole 12 is connected with a tube assembly 7, which divides the second through-hole 12 into an inlet portion 121 and an outlet portion 122. The tube assembly 7 includes a tube divider 71. The tube divider 71 is disposed in the tube assembly 7 and divides an interior of the tube assembly 7 into a first air channel 7a and a second air channel 7b. The first air channel 7a intercommunicates with the inlet portion 121 and the second air channel 7b intercommunicates with the outlet portion 122. In addition, the tube divider 71 is integrally formed with a plurality of fins 72. The plurality of fins 72 is received in the first air channel 7a and the second air channel 7b.

Referring to FIGS. 1, 2 and 3 again, the first fan unit 2 is received in the compartment S of the housing 1. The first fan unit 2 includes a first air inlet 21 and a first air outlet 22. The first air inlet 21 intercommunicates with the inlet portion 121 of the second through-hole 12 of the housing 1 and the first air channel 7a of the tube assembly 7. The first air outlet 22 intercommunicates with the first through-hole 11 of the housing 1.

Still referring to FIGS. 1, 2 and 3, the second fan unit 3 is received in the compartment S of the housing 1. The second fan unit 3 includes a second air inlet 31 and a second air outlet 32. The second air inlet 31 intercommunicates with the third through-hole 13 of the housing 1. The second air outlet 32 intercommunicates with the outlet portion 122 of the second through-hole 12 of the housing 1 and the second air channel 7b of the air guider 7′.

Referring to FIGS. 2 and 3, based on the above structure, during the use of the air exchanging device according to the invention, the wall can have only a single installation hole. The second through-hole 12 of the housing 1 intercommunicates with the tube assembly 7 mounted to the installation hole of the wall. In this arrangement, during the operation of the first fan unit 2 and the second fan unit 3, the external air can be guided from the inlet portion 121 of the second through-hole 12 to the first air inlet 21 of the first fan unit 2, and then is guided to the indoor space via the first air outlet 22 of the first fan unit 2. Furthermore, the internal air can also be guided from the second air inlet 31 to the second air outlet 32 of the second fan unit 3, and then is guided to the outdoor space via the outlet portion 122 of the second through-hole 12. Accordingly, the air is circulated between the indoor and outdoor spaces to provide a desired ventilation effect.

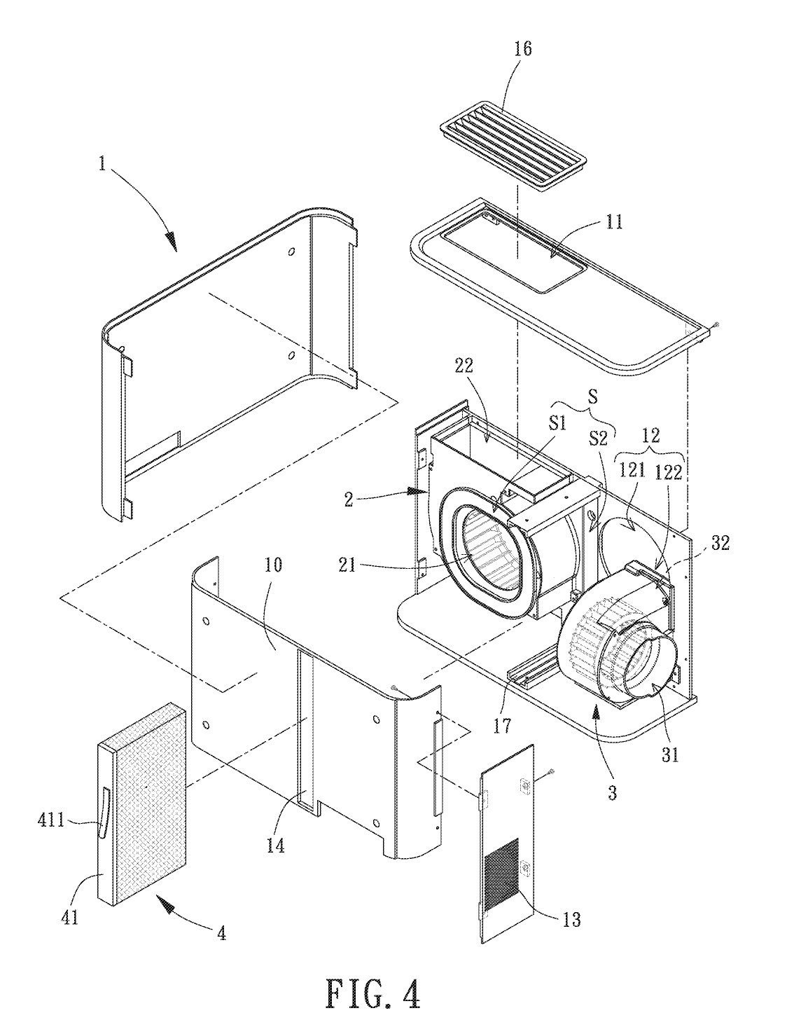

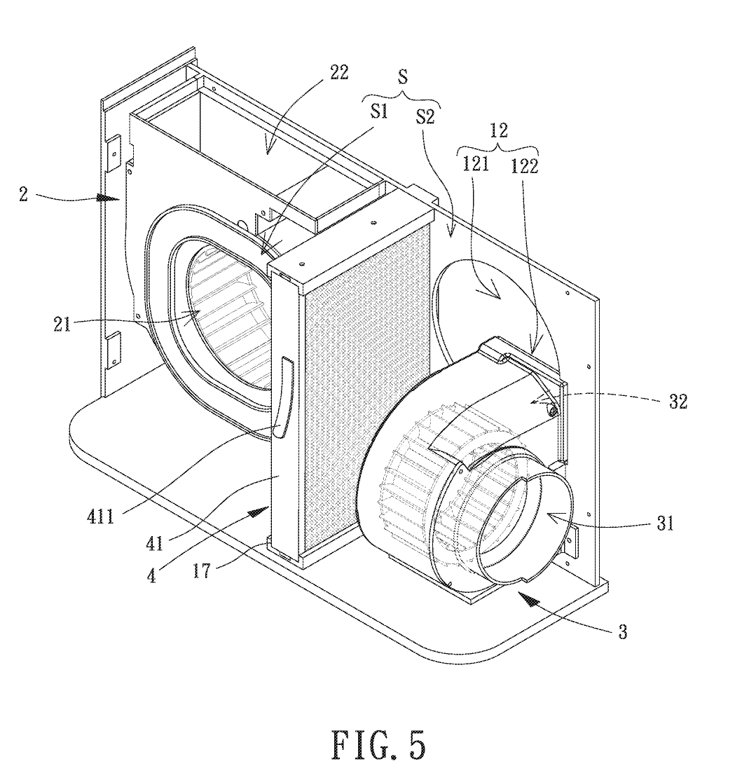

FIGS. 4 and 5 show an air exchanging device according to a second embodiment of the invention. The second embodiment is substantially the same as the first embodiment except for that the air exchanging device in the second embodiment further includes a first filter 4 and the housing 1 includes a rail 17. The first filter 4 is detachably mounted to the rail 17 and divides the compartment S into a first compartment S1 and a second compartment S2. The first fan unit 2 is received in the first compartment S1 and the second fan unit 3 is received in the second compartment S2. The first filter 4 includes a first side board 41. The housing 1 includes an inner member 10 having a fourth through-hole 14 corresponding to the first side board 41, such that the first filter 4 can be inserted into or withdrawn from the compartment S via the fourth through-hole 14. The first side board 41 includes a first pulling portion 411. When it is needed to clean or change the first filter 4, the first filter 4 can smoothly slide along the rail 17 and can be withdrawn from the compartment S via the fourth through-hole 14 easily. The first pulling portion 411 can be in the form of a grip or a strip.

Referring to FIGS. 4 and 5, it is noted that the first filter 4 preferably includes a filtration material which can provide a filtration function and meets the air quality standard of PM 2.5 or similar. Based on this, the first filter 4 is able to filter out the particulate matter of around 2.5 m or above, ensuring that the air flowing through the first air inlet 21 of the first fan unit 2 meets the air quality standard of PM 2.5. Besides, the first filter 4 may be a High Efficiency Particulate Air filter (HEPA filter), an Ultra Low Penetration Air filter (ULPA filter) or a Volatile Organic Compounds Air filter (VOC filter). One of the filters can be chosen depending on the requirement. However, the above is not used to limit the invention.

Referring to FIGS. 4 and 5, based on the above structure, the external air that is drawn from the inlet portion 121 of the second through-hole 12 will pass through the first filter 4 during the operation of the first fan unit 2 and the second fan unit 3. The first filter 4 filters the air passing therethrough. The filtered air is guided to the first air inlet 21 of the first fan unit 2 and then is guided into the indoor space via the first air outlet 22. Moreover, the internal air can also be guided to the outside via the second air inlet 31, the second air outlet 32 and the outlet portion 122 in sequence. Based on this, the internal air can exchange with the external air to provide a desired ventilation function while purifying the air.

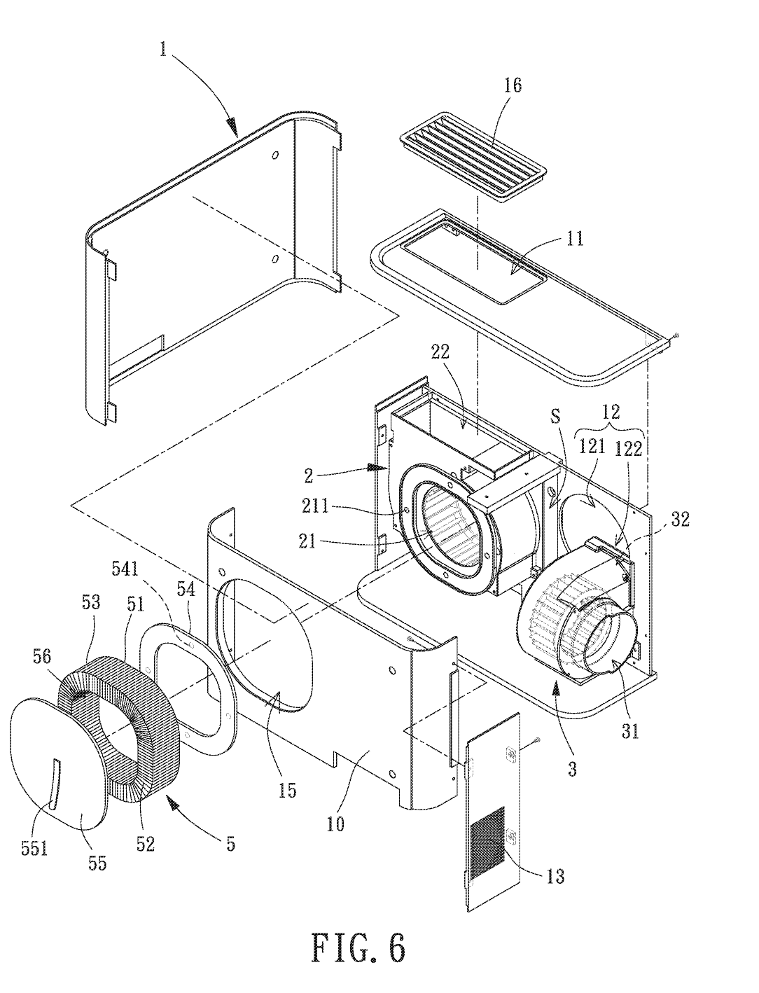

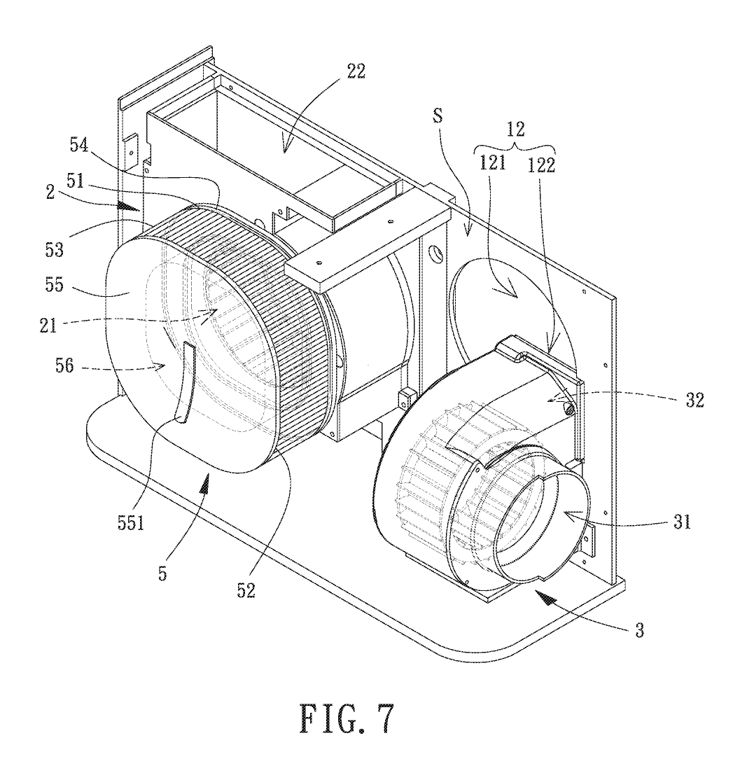

FIGS. 6 and 7 show an air exchanging device according to a third embodiment of the invention. The third embodiment is substantially the same as the first embodiment except for that the air exchanging device in the third embodiment further includes a second filter 5. The second filter 5 is coupled with the first fan unit 2 and covers the first air inlet 21. The second filter 5 includes a first end 51, a second end 52, and a hole 56 extending from the first end 51 to the second end 52. A filtration wall 53 is disposed between the first end 51 and the second end 52. In addition, a third side board 54 includes a plurality of second positioning portions 541. The first fan unit 2 includes a plurality of first positioning portions 211 surrounding the first air inlet 21. The plurality of second positioning portions 541 can be coupled with the plurality of first positioning portions 211 by ways of magnetic attraction, engagement or adhesion.

In addition, referring to FIGS. 6, 7, 8 and 9, the second end 52 of the second filter 5 is coupled with a second side board 55, such that the hole 56 forms an air-guiding space 57. The filtration wall 53 of the second filter 5 is exposed to the outside. Since the first end 51 and the second end 52 of the second filter 5 are covered, the air flows through the filtration wall 53 and into the air-guiding space 57. Thus, a smooth air-guiding effect is attained. Besides, the housing 1 includes an inner member 10. The inner member 10 includes a fifth through-hole 15 corresponding to the second filter 5, such that the second filter 5 can be installed into or withdrawn from the compartment S via the fifth through-hole 15. The second side board 55 includes a second pulling portion 551. When it is needed to clean or change the second filter 5, the second filter 5 can be withdrawn from the compartment S via the fifth through-hole 15. The second pulling portion 551 preferably can be in the form of a grip or a strip.

Referring to FIGS. 6 and 7, it is noted that the second filter 5 preferably includes a filtration material which can provide a filtration function and meets the air quality standard of PM 2.5 or similar. Based on this, the second filter 5 is able to filter out the particulate matter of around 2.5 μm or above, ensuring that the air flowing through the first air inlet 21 of the first fan unit 2 meets the air quality standard of PM 2.5. Besides, the second filter 5 may be a High Efficiency Particulate Air filter (HEPA filter), an Ultra Low Penetration Air filter (ULPA filter) or a Volatile Organic Compounds Air filter (VOC filter). One of the filters can be chosen depending on the requirement. However, the above is not used to limit the invention.

Referring to FIGS. 6, 7, 8 and 9, based on the above structure, the external air that is drawn from the inlet portion 121 of the second through-hole 12 will pass through the filtration wall 53 of the second filter during the operation of the first fan unit 2 and the second fan unit 3. The filtration wall 53 of the second filter 5 filters the air passing therethrough. The filtered air is guided to the air-guiding space 57. Then, the air is guided to the first air inlet 21 of the first fan unit 2 and then into the indoor space via the first air outlet 22. Moreover, the internal air can also be guided to the outside via the second air inlet 31, the second air outlet 32 and the outlet portion 122 in sequence. Based on this, the internal air can exchange with the external air to provide a desired ventilation function while purifying the air.

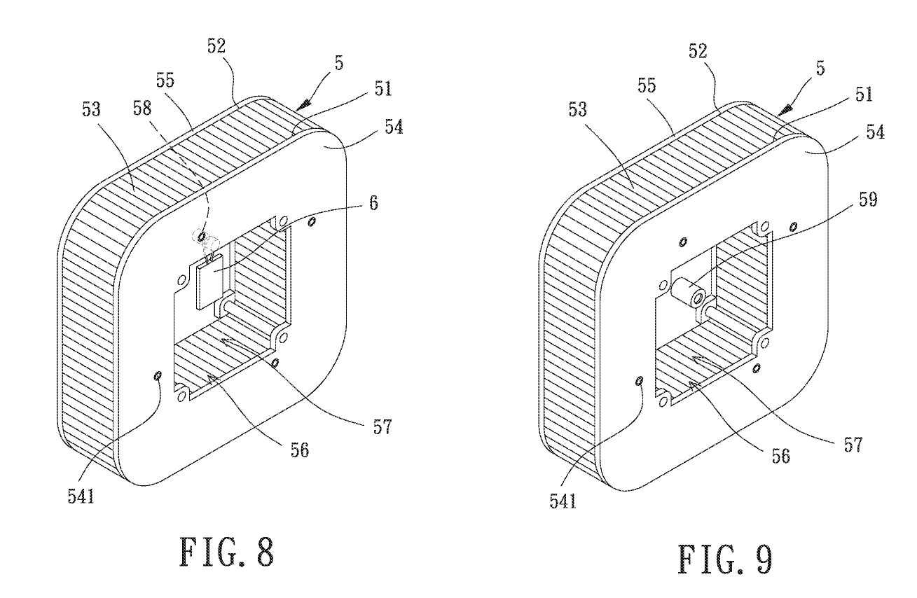

Referring to FIGS. 8 and 9, an air freshener 6 is disposed in the air-guiding space 57 of the second filter 5 in order to provide a pleasant smell, as shown in FIG. 8. The air freshener 6 is preferably hanged on a post 58 which may be in the form of a hook. The post 58 is preferably located on the second side board 55 and extends into the air-guiding space 57 of the second filter 5. The air freshener 6 may be a sachet or a bag with dried flowers. Alternatively, a receiving portion 59 may be provided as shown in FIG. 9. The receiving portion 59 may receive fragrance liquor. The receiving portion 59 is preferably formed at one side of the second side board 55 and extends into the air-guiding space 57 of the second filter 5. The fragrance liquor may be an essential oil or perfume. Thus, the filtered air can bring the fragrance of the air freshener 6 or the fragrance liquor into the first fan unit 2 through the air-guiding space 57. Accordingly, the filtered air and the fragrance are discharged from the first air outlet 22 to scent the air with fragrance, relaxing the users mentally and physically.

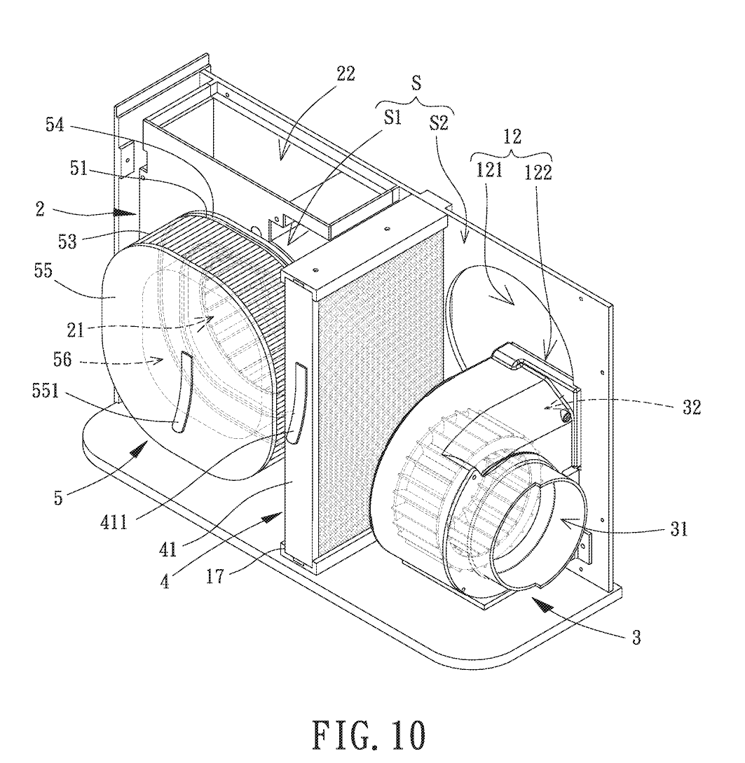

FIG. 10 shows an air exchanging device according to a fourth embodiment of the invention. The fourth embodiment is substantially the same as the second and third embodiments except for that both the first filter 4 and the second filter 5 are included in the fourth embodiment. The second filter 5 has interstices smaller than or equal to that of the first filter 4. The first filter 4 is preferably a VOC filter (Volatile Organic Compounds Air filter). The second filter 5 preferably includes a filtration material which meets the air quality standard of PM 2.5. In this arrangement, the external air that is drawn from the inlet portion 121 of the second through-hole 12 will pass through the first filter 4 and the second filter 5 in sequence. After two layers of filtration process provided by the first filter 4 and the second filter 5, the filtered air is guided into the indoor space via the first air inlet 21 and the first air outlet 22 in sequence. Moreover, the internal air can be guided to the outer space via the second air inlet 31, the second air outlet 32 and the outlet portion 122 in sequence. In this arrangement, the internal air and the external air can exchange with each other to provide a desired ventilation effect while the filtration of the air is attained.

In summary, the air exchanging device according to the invention simply requires that a single installation hole be formed on the wall, such that the second through-hole of the housing of the air exchanging device intercommunicates with a tube assembly mounted to the installation hole of the wall. In this arrangement, during the operation of the first and second fan units, the external air can be guided from the second through-hole to the first air inlet of the first fan unit, and then is guided to the indoor space via the first air outlet of the first fan unit. Furthermore, the internal air can also be guided from the second air inlet to the second air outlet of the second fan unit, and then is guided to the outdoor space via the second through-hole. Accordingly, the air is circulated between the indoor and outdoor spaces to provide a desired ventilation effect while the small particles and unpleasant smell of the air can be filtered out to provide an air-cleaning effect.

Although the invention has been described in detail with reference to its presently preferable embodiments, it will be understood by one of ordinary skill in the art that various modifications can be made without departing from the spirit and the scope of the invention, as set forth in the appended claims.

What is claimed is:

1. An air exchanging device comprising:
a housing having a compartment, wherein the housing has a first through-hole, a second through-hole and a third through-hole;
a first fan unit received in the compartment and including a first air inlet intercommunicating with the second through-hole, and a first air outlet intercommunicating with the first through-hole; and
a second fan unit received in the compartment and including a second air inlet intercommunicating with the third through-hole, and a second air outlet intercommunicating with the second through-hole.

2. The air exchanging device as claimed in claim 1, wherein the second through-hole includes an inlet portion intercommunicating with the first air inlet, and an outlet portion intercommunicating with the second air outlet.

3. The air exchanging device as claimed in claim 2, wherein the second through-hole of the housing is divided into the inlet portion and the outlet portion by an air guider.

4. The air exchanging device as claimed in claim 3, wherein the air guider includes at least a tube assembly.

5. The air exchanging device as claimed in claim 4, wherein the tube assembly includes a tube divider disposed therein and dividing an interior of the tube assembly into a first air channel and a second air channel, and wherein the first air channel intercommunicates with the inlet portion of the second through-hole and the second air channel intercommunicates with the outlet portion of the second through-hole.

6. The air exchanging device as claimed in claim 5, wherein the tube divider is integrally formed with a plurality of fins received in the first and second air channels.

7. The air exchanging device as claimed in claim 1, further comprising a first filter disposed in the compartment and dividing the compartment into a first compartment and a second compartment.

8. The air exchanging device as claimed in claim 7, wherein the first filter includes a first side board having a first pulling portion, and wherein the housing includes an inner member having a fourth through-hole corresponding to the first side board.

9. The air exchanging device as claimed in claim 8, wherein the housing includes a rail, and wherein the first filter is detachably mounted to the rail.

10. The air exchanging device as claimed in claim 1, wherein the housing includes a grid plate disposed at the first through-hole.

11. The air exchanging device as claimed in claim 1, further comprising a filter coupled with the first fan unit and covering the first air inlet, wherein the filter includes a first end, a second end, and a hole extending from the first end to the second end thereof.

12. The air exchanging device as claimed in claim 11, wherein a filtration wall is disposed between the first and second ends of the filter.

13. The air exchanging device as claimed in claim 11, wherein the first end of the filter is coupled with a third side board, wherein the first fan unit includes a plurality of first positioning portions surrounding the first air inlet thereof, and wherein the third side board includes a plurality of second positioning portions coupled with the plurality of first positioning portions.

14. The air exchanging device as claimed in claim 13, wherein the plurality of second positioning portions is coupled with the plurality of first positioning portions by ways of magnetic attraction, engagement or adhesion.

15. The air exchanging device as claimed in claim 11, wherein the second end of the filter is coupled with a second side board, and wherein the hole forms an air-guiding space.

16. The air exchanging device as claimed in claim 15, wherein the second side board includes a second pulling portion, wherein the housing includes an inner member having a fifth through-hole corresponding to the filter.

17. The air exchanging device as claimed in claim 16, wherein an air freshener is disposed in the air-guiding space and is hanged on a post or a hook.

18. The air exchanging device as claimed in claim 16, wherein the air-guiding space includes a receiving portion receiving a fragrance liquor.

19. The air exchanging device as claimed in claim 7, further comprising a second filter coupled with the first fan unit and covering the first air inlet, wherein the second filter has interstices smaller than or equal to that of the first filter.

20. The air exchanging device as claimed in claim 7, wherein the first filter comprises a filtration material which meets an air quality standard of PM 2.5, a High Efficiency Particulate Air filter (HEPA filter), an Ultra Low Penetration Air filter (ULPA filter), or a Volatile Organic Compounds Air filter (VOC filter).

21. The air exchanging device as claimed in claim 11, wherein the second filter comprises a filtration material which meets an air quality standard of PM 2.5, a High Efficiency Particulate Air filter (HEPA filter), an Ultra Low Penetration Air filter (ULPA filter), or a Volatile Organic Compounds Air filter (VOC filter).

22. The air exchanging device as claimed in claim 1, wherein the first, second and third through-holes are formed on different faces of the housing.

23. The air exchanging device as claimed in claim 19, wherein the first filter is a Volatile Organic Compounds Air filter (VOC filter) and the second filter comprises a filtration material which meets an air quality standard of PM 2.5.
